(19) United States
(12) Patent Application Publication
(10) Pub. No.: US 2024/0383675 A1
(43) Pub. Date: Nov. 21, 2024

(54) Detachable Trash Can Device

(71) Applicant: Leonard Garcia, Thornton, CO (US)

(72) Inventor: Leonard Garcia, Thornton, CO (US)

(21) Appl. No.: 18/494,869

(22) Filed: Oct. 26, 2023

Related U.S. Application Data
(60) Provisional application No. 63/467,696, filed on May 19, 2023.

(51) Int. Cl. B65F 1/16; B65F 1/06

(52) U.S. Cl. CPC B65F 1/16; B65F 1/06

(57) ABSTRACT

A detachable trash can device is provided. The device is primarily comprised of a body in which a trash bag may be placed for a user to dispose of items. A lid assembly and a base may be removably attached to the body such that the components may be taken apart to more thoroughly clean and sanitize the device. The base is also comprised of a foot pedal that, when pressed, may release the body from the base, eliminating the vacuum effect acting on a trash bag and making it easier to remove the trash bag placed in the body of the device.

### CROSS-REFERENCE TO RELATED APPLICATION

The present application claims priority to, and the benefit of, U.S. Provisional Application No. 63/467,696, which was filed on May 19, 2023, and is incorporated herein by reference in its entirety.

### FIELD OF THE INVENTION

The present invention relates generally to the field of trash cans. More specifically, the present invention relates to a detachable trash can device with a lid assembly and a base that is removably attached to the body, such that the components may be taken apart to more thoroughly clean and sanitize the device. The base is also comprised of a foot pedal that, when pressed, may release the body from the base, eliminating the vacuum effect acting on a trash bag and making it easier to remove the trash bag placed in the body of the device. Accordingly, the present disclosure makes specific reference thereto. Nonetheless, it is to be appreciated that aspects of the present invention are also equally applicable to other like applications, devices, and methods of manufacture.

### BACKGROUND

Removing a filled trash bag from a trash can often present challenges, primarily because of the potential for the bag to adhere to the inner walls of the trash can. This adherence is typically caused by a phenomenon known as the vacuum effect. When a trash bag is filled and pressed against the interior of the can, the air between the bag and the can is pushed out, creating a suction-like force that holds the bag in place. This vacuum effect can make it notably strenuous for individuals to smoothly and effortlessly remove the bag, especially if it is packed to capacity.

Furthermore, existing trash cans available in the market are designed as a singular unit without detachable parts. This design choice not only complicates the process of removing a stubborn bag, but also poses challenges when it comes to thoroughly cleaning and sanitizing the trash can. Residue and waste can accumulate over time, and without the ability to disassemble or access all parts of the can, ensuring its cleanliness becomes a daunting task.

Therefore, there exists a long-felt need in the art for an improved trash can. More specifically, there exists a long-felt need in the art for a detachable trash can device that eliminates the vacuum effect of existing trash cans while removing trash bags from the device. Furthermore, there exists a long-felt need in the art for a detachable trash can device that can be easily deep cleaned and sanitized.

The subject matter disclosed and claimed herein, in one embodiment thereof, comprises a detachable trash can device. The device is primarily comprised of a body, a lid assembly, and a base. The lid assembly and the base may be removably attached to the body, allowing the components to be separated and easily cleaned. Further, a foot pedal of the base, when pressed, may detach the body from the base, eliminating the vacuum effect acting on a trash bag and making it easier to remove the trash bag placed in the body of the device.

In this manner, the detachable trash can device of the present invention accomplishes all the foregoing objectives and provides an improved trash can. More specifically, the detachable trash can device can eliminate the vacuum effect that makes it difficult to remove full trash bags from the device. Furthermore, the detachable trash can device can be separated into individual components that allows the device to be more easily fully cleaned and sanitized.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a detachable trash can device primarily comprised of a body, a lid assembly, and a base. The device is designed to allow a user to more easily remove a trash bag from the device by stopping the vacuum effect experienced in most single-piece trash cans.

The device is comprised of a body in which a trash bag may be placed. The body is removably attached to a lid assembly on one end and a base on the other end. The lid assembly may retain the contents in the interior space of the body. A base of the lid assembly may be placed on the body and be secured to the body via a locking mechanism. A lid may be attached to the base of the lid assembly via at least one hinge that allows the lid assembly to easily open and close. A user may grip a handle of the lid assembly to open and close the lid.

The base may accept the body of the device and may be weighted to further stabilize the device. The base is also comprised of a locking mechanism that can further secure the base to the body. The locking mechanism may be activated by a foot pedal, such that when a user pushes the foot pedal down, the locking mechanism may either activate or deactivate. By detaching the locking mechanism, the vacuum seal on the trash bag may be released, allowing the trash bag to be easily removed from the body of the device.

The present invention is also comprised of a method of using the device. First, a device is provided primarily comprised of a body, a lid assembly, and a base. Then, the body may be placed into the base and secured to the base via a locking mechanism of the base. Then, the lid assembly may be placed onto the body. Next, a trash bag may be placed into the interior space of the body. Then, the locking mechanism of the base may be deactivated by pressing down on the foot pedal, allowing the trash bag to be easily removed from the body of the device. Finally, the locking mechanisms of the lid assembly and the base may be deactivated, detaching the lid assembly, the body, and the base such that the device may be thoroughly cleaned and sanitized as needed.

Accordingly, the detachable trash can device of the present invention is particularly advantageous as it provides a device that improves on the trash can. More specifically, the detachable trash can device can be separated into individual components that can be more easily and thoroughly cleaned and sanitized. Furthermore, the detachable trash can device allows the trash bag to be easily removed by preventing the vacuum effect from holding the trash bag in place. In this manner, the detachable trash can device overcomes the limitations of existing trash cans known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of a detachable trash can device of the present invention in accordance with the disclosed architecture;

FIG. 2 illustrates a front perspective view of one potential embodiment of a detachable trash can device of the present invention without a lid in accordance with the disclosed architecture;

FIG. 3 illustrates a rear perspective view of one potential embodiment of a detachable trash can device of the present invention in accordance with the disclosed architecture;

FIG. 4 illustrates a perspective view of a base of one potential embodiment of a detachable trash can device of the present invention in accordance with the disclosed architecture; and

FIG. 5 illustrates a flowchart of a method of using one potential embodiment of a detachable trash can device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved trash can. More specifically, there exists a long-felt need in the art for a detachable trash can device that eliminates the vacuum effect of existing trash cans while removing trash bags from the device. Furthermore, there exists a long-felt need in the art for a detachable trash can device that can be easily deep cleaned and sanitized.

The present invention, in one exemplary embodiment, is comprised of a detachable trash can device. The device is primarily comprised of a body, a lid assembly, and a base. The device is designed to allow a user to more easily remove a trash bag from the device by stopping the vacuum effect experienced in most single-piece trash cans.

More specifically, the device is comprised of a generally rectangular body. The body may be made from any material but is preferably made from a lightweight metal or plastic material. The body may be further comprised of an interior space, at least one handle, and an opening. A trash bag may be placed into the interior space of the body by pushing the trash bag through the opening. The handle may be a point of contact for a user to easily grip and lift the device to move the device to a different location.

The device may be further comprised of a lid assembly that may help to retain the contents in the interior space of the body. The lid assembly may be further comprised of a base, a lid, a handle, and a locking mechanism. The base of the lid assembly may be wide, such that the lid assembly easily fits over the body of the device. The lid may be attached to the base of the lid assembly via at least one hinge that allows the lid assembly to easily open and close. The handle of the lid assembly may act as a contact point for a user attempting to open or close the lid. The locking mechanism of the lid assembly may be activated to secure the base of the lid assembly to the body of the device.

The device may be further comprised of a base that may accept the body of the device. In one potential embodiment, the base may be weighted or comprised of a grip area that provides stability to the device and prevents the device from tipping over. The base is further comprised of four side walls and a bottom wall that may provide additional stability to the structure of the device. The base is also comprised of a locking mechanism that may secure the body to the base. In one potential embodiment, the locking mechanism may be a clipping mechanism that may be deactivated by pressing down a foot pedal. In differing embodiments, the locking mechanism may be any mechanism that can be activated by a foot pedal. Further, the foot pedal, in differing embodiments, may be any object such as a latch, lever, button, etc., that can be easily operated by a user to activate and deactivate the locking mechanism of the base of the device.

The present invention is also comprised of a method of using the device. First, a device is provided primarily comprised of a body, a lid assembly, and a base. Then, the body may be placed into the base and secured to the base via a locking mechanism of the base. Then, the lid assembly may be placed onto the body. Next, a trash bag may be placed into the interior space of the body. Then, the locking mechanism of the base may be deactivated by pressing down on the foot pedal, allowing the trash bag to be easily removed from the body of the device. Finally, the locking mechanisms of the lid assembly and the base may be deactivated, detaching the lid assembly, the body, and the base such that the device may be thoroughly cleaned and sanitized as needed.

Accordingly, the detachable trash can device of the present invention is particularly advantageous as it provides a device that improves on the trash can. More specifically, the detachable trash can device may prevent the vacuum effect from holding the trash bag in place, allowing the trash bag to be more easily removed from the device. Furthermore, the detachable trash can device can be easily cleaned and sanitized by separating the device into its individual components. In this manner, the detachable trash can device overcomes the limitations of existing trash cans known in the art.

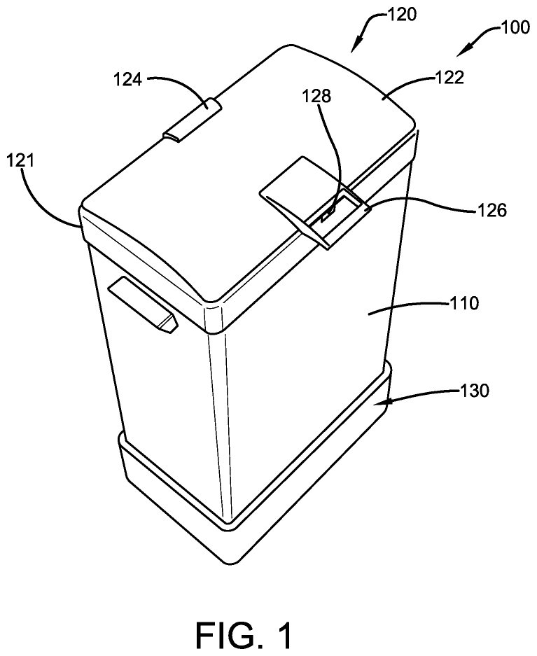

Referring initially to the drawings, FIG. 1 illustrates a front perspective view of one potential embodiment of a detachable trash can device 100 of the present invention in accordance with the disclosed architecture. The device 100 is primarily comprised of a body 110, a lid assembly 120, and a base 130. The device 100 is designed to allow a user to remove a trash bag more easily from the device 100 by preventing/stopping the vacuum effect experienced in most single-piece trash cans.

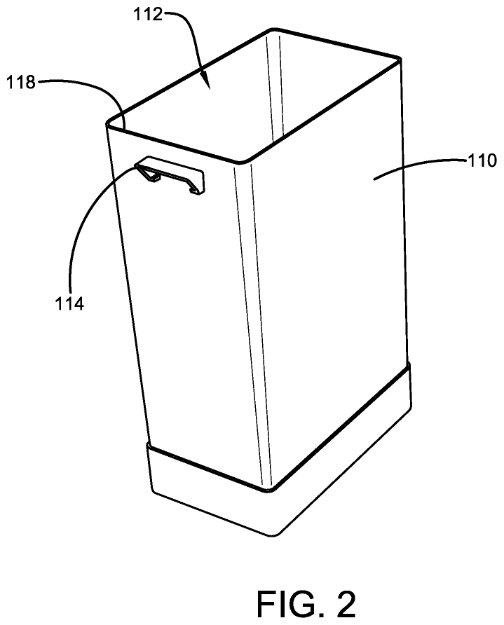

The device 100 is comprised of a body 110 that is generally rectangular in shape. However, the body 110 may be any shape, size, and configuration in different embodiments. The body 110 may further be made from any material but is preferably made from a lightweight metal, such as stainless steel or aluminum, or a plastic material. The body 110 is comprised of an interior space 112 in which a trash bag may be placed, such that the trash placed in the body 110 of the device 100 may be easily removed. A trash bag may be placed into the interior space 112 of the body 110 by passing the trash bag through an opening 116 of the body 110. In one potential embodiment, the body 110 may be further comprised of at least one handle 114, as can be seen in FIG. 2. A user may grip the body 110 by the handle 114 to move the device 100 to a different location.

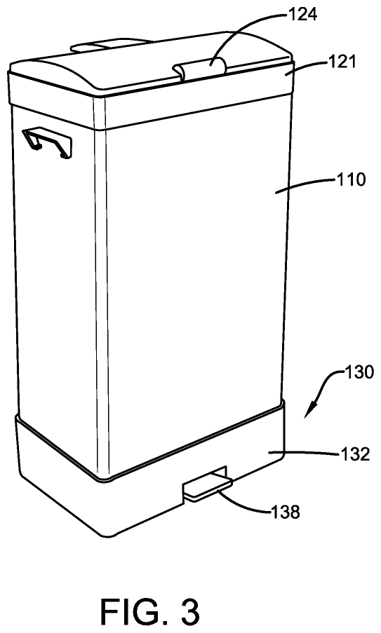

FIG. 3 illustrates a rear perspective view of one potential embodiment of a detachable trash can device 100 of the present invention in accordance with the disclosed architecture. The lid assembly 120 is removably attached to the body 110 and may prevent any contents or smells in the interior space 112 of the body 110 from leaking out. The lid assembly 120 may further be comprised of a base 121, a lid 122, at least one handle 126, and at least one locking mechanism 128. The base 121 of the lid assembly 120 may be slightly wider than the body 110 such that it may be placed onto the body 110. The lid 122 may be attached to the base 121 of the lid assembly 120 via at least one hinge 124 that allows the lid assembly 120 to easily open to and close off the interior space 112 of the body 110. A user may grip the lid assembly 120 via the handle 126 to easily open and close the lid assembly 120. Further, a locking mechanism 128 of the lid assembly 120 may secure the lid 122 to the base 121 to prevent the lid 122 from opening. The mechanism 128 may be any type such as, but not limited to, a latch, a clip, a lock, etc.

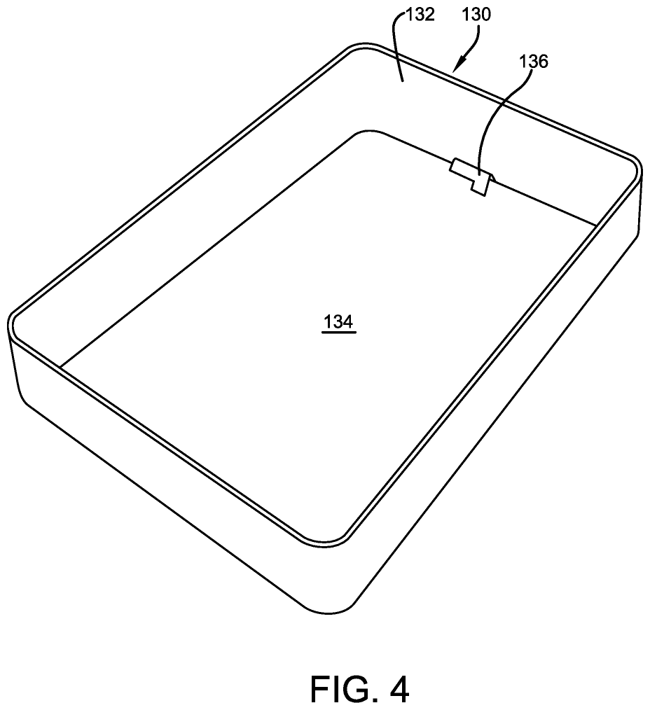

FIG. 4 illustrates a perspective view of a base 130 of one potential embodiment of a detachable trash can device 100 of the present invention in accordance with the disclosed architecture. The base 130 also removably attaches to the body and may provide stability to the device 100 by providing additional weight or being comprised of a material that enhances grip of the surface on which the device 100 rests upon, in differing embodiments. The base 130 may be generally rectangular in shape to conform to the shape of the body 110 such that the base 130 is comprised of four side walls 132 and a bottom wall 134.

The base 130 is also comprised of at least one locking mechanism 136 that may secure the base 130 to the body 110 of the device 100. In the preferred embodiment of the device 100, the locking mechanism 136 of the base 130 is a latch or clip mechanism that may be disengaged by pressing down on at least one foot pedal 138. In differing embodiments, however, the locking mechanism 136 may be any mechanism that can secure the base 130 to the body 110 of the device 100. The locking mechanism 136 may automatically lock the base 130 to the body 110 when the body 110 is placed into the base 130. By pressing down on the foot pedal 138, the locking mechanism 136 may disengage, releasing the body 110 from the base 130 and stopping any vacuum seal on a trash bag in the body 110. In differing embodiments, the foot pedal 138 may be any object, such as a button, a lever, a latch, etc., that can be easily operated by a user to activate and/or deactivate the locking mechanism 136 of the base 130.

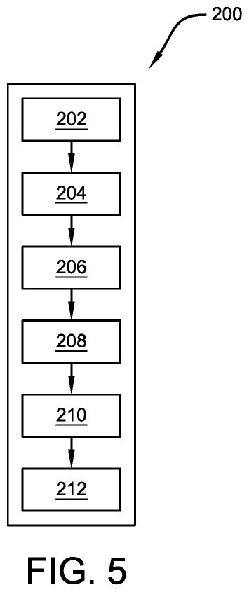

The present invention is also comprised of a method 200 of using the device 100, as seen in FIG. 5. First, a device 100 is provided primarily comprised of a body 110, a lid assembly 120 that removably attaches to the body 110, and a base 130 that removably attaches to the body 110 wherein the base 130 is comprised of a locking mechanism 136 that secures the base 130 to the body 110 [Step 202]. Then, the body 110 may be placed into the base 130 and secured to the base 130 via a locking mechanism 136 of the base 130 [Step 204]. Then, the lid assembly 120 may be placed onto the body 110 [Step 206]. Next, a trash bag may be placed into the interior space 112 of the body 110 [Step 208]. Then, the locking mechanism 136 of the base 130 may be deactivated by pressing down on the foot pedal 138, allowing the trash bag to be easily removed from the body 110 of the device 100 [Step 210]. Finally, the locking mechanisms 128, 136 of the lid assembly 120 and the base 130 may be deactivated, detaching the lid assembly 120, the body 110, and the base 130 such that the device 100 may be thoroughly cleaned and sanitized as needed [Step 212].

All components of the device 100 are preferably dishwasher safe to allow the components to be easily washed.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “detachable trash can device” and “device” are interchangeable and refer to the detachable trash can device 100 of the present invention.

Notwithstanding the foregoing, the detachable trash can device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the detachable trash can device 100 as shown in the FIGS. are for illustrative purposes only, and that many other sizes and shapes of the detachable trash can device 100 are well within the scope of the present disclosure. Although the dimensions of the detachable trash can device 100 are important design parameters for user convenience, the detachable trash can device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A detachable trash can device comprising:
a body comprised of an opening and an interior space;
a lid assembly comprised of a base and a lid that attaches to the base via a hinge; and
a base comprised of a first locking mechanism and a foot pedal.

2. The detachable trash can device of claim 1, wherein the lid is comprised of a handle.

3. The detachable trash can device of claim 1 further comprised of a second locking mechanism.

4. The detachable trash can device of claim 3, wherein the second locking mechanism secures the lid to the base.

5. The detachable trash can device of claim 1, wherein the first locking mechanism is comprised of a latch or a clip.

6. The detachable trash can device of claim 5, wherein the first locking mechanism can be disengaged by the foot pedal.

7. The detachable trash can device of claim 1, wherein the detachable trash can device is comprised of a dishwasher-safe material.

8. A detachable trash can device comprising:
a body comprised of a handle, an opening, and an interior space;
a lid assembly comprised of a base and a lid that attaches to the base via a hinge; and
a base comprised of a first locking mechanism and a disengaging mechanism.

9. The detachable trash can device of claim 8, wherein the lid is comprised of a handle.

10. The detachable trash can device of claim 8 further comprised of a second locking mechanism.

11. The detachable trash can device of claim 10, wherein the second locking mechanism secures the lid to the base.

12. The detachable trash can device of claim 8, wherein the first locking mechanism is comprised of a latch or a clip.

13. The detachable trash can device of claim 8, wherein the first locking mechanism can be disengaged by the disengaging mechanism.

14. The detachable trash can device of claim 13, wherein the disengaging mechanism is comprised of a foot pedal, a button, a lever, or a latch.

15. The detachable trash can device of claim 8, wherein the detachable trash can device is comprised of a dishwasher-safe material.

16. A method of using a detachable trash can device, the method comprising the following steps:
providing a detachable trash can device comprised of a body, a lid assembly that removably attaches to the body, and a base that removably attaches to the body, the base comprised of a locking mechanism that secures the base to the body;
placing the body into the base;
placing the lid assembly onto the body;
placing a trash bag into an interior space of the body; and
deactivating the locking mechanism to allow the trash bag to be removed from the interior space.

17. The method of using a detachable trash can device of claim 16, wherein the locking mechanism is deactivated by pressing down a foot pedal of the base.

18. The method of using a detachable trash can device of claim 16, wherein the locking mechanism is comprised of a latch.

19. The method of using a detachable trash can device of claim 16 further comprised of a step of detaching the lid assembly and the base from the body.

20. The method of using a detachable trash can device of claim 19 further comprised of a step of cleaning the lid assembly, the base, and the body.
